(19) United States
(12) Patent Application Publication
(10) Pub. No.: US 2009/0002659 A1
(43) Pub. Date: Jan. 1, 2009

(54) STAGE APPARATUS, EXPOSURE APPARATUS, AND METHOD OF MANUFACTURING DEVICE

(75) Inventor: Yoshihisa Hiyama, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/128,854

(22) Filed: May 29, 2008

(30) Foreign Application Priority Data
Jun. 29, 2007 (JP) 2007-173108

(51) Int. Cl. G03B 27/42

(52) U.S. Cl. 355/53

(57) ABSTRACT

This invention discloses a stage apparatus including a first stage (104) and a second stage (105) mounted on the first stage (104). A linear motor (103) positions the second stage (105) relative to the first stage (104). A plurality of electromagnets (106a-106d) accelerate and decelerate the second stage (105) relative to the first stage (104). A controller controls the electromagnets (106a-106d) so as to reduce moments generated by the electromagnets (106a-106d) due to rotation of the second stage (105).

### BACKGROUND OF THE INVENTION

1. Field of the Invention

The present invention relates to a stage apparatus, an exposure apparatus, and a method of manufacturing a device.

2. Description of the Related Art

The so-called stepper and scanner are known as exposure apparatuses used to manufacture semiconductor devices. The stepper reduces and projects a pattern image formed on a reticle onto a semiconductor wafer on a stage apparatus via a projection lens to sequentially transfer the pattern image onto a plurality of portions on the wafer, while moving the wafer under the projection lens in steps. The scanner projects the pattern of a reticle on a reticle stage onto a wafer on a wafer stage by irradiating the wafer with slit-like exposure light, while scanning the wafer and reticle relative to a projection lens. The stepper and scanner are expected to be mainstream exposure apparatuses from the viewpoints of the resolution and alignment accuracy.

One apparatus performance index is the throughput which indicates the number of wafers processed per unit time. To attain a high throughput, the wafer stage and reticle stage are required to move at high speed. Under the circumstance, Japanese Patent Laid-Open No. 2005-243751 proposes a stage apparatus having a coarse motion stage and fine motion stage in order to attain high-speed driving while suppressing heat generation. In accelerating and decelerating the coarse motion stage, a coarse motion linear motor is used. In accelerating and decelerating the fine motion stage, it is accelerated and decelerated by electromagnets in which heat generation is suppressed, and is positioned by a fine motion linear motor. This suppresses heat generation by the fine motion linear motor, thus suppressing adverse thermal effects.

When the reticle is mounted on the reticle stage in a misaligned state, the fine motion stage can be scan-driven while being rotated relative to the coarse motion stage. However, the rotation of the fine motion stage shifts the points of action of the forces of the electromagnets, and therefore generates unwanted moments. Furthermore, the rotation of the fine motion stage changes the gaps between the fine motion stage and the electromagnets, and therefore generates unwanted moments. When these moments are suppressed by controlling the rotation of the fine motion linear motor, the heat generation amount may increase, resulting in adverse thermal effects.

### SUMMARY OF THE INVENTION

It is an object of the present invention to provide a stage apparatus which reduces any moments generated by electromagnets due to rotation of a fine motion stage by controlling the electromagnets, thereby suppressing heat generation by a fine motion linear motor.

According to the first aspect of the present invention, there is provided a stage apparatus comprising, a first stage, a second stage mounted on the first stage, a linear motor configured to position the second stage relative to the first stage, a plurality of electromagnets configured to accelerate and decelerate the second stage relative to the first stage, and a controller configured to control the plurality of electromagnets, wherein the controller controls the electromagnets so as to reduce moments generated by the electromagnets due to rotation of the second stage.

According to the second aspect of the present invention, there is provided a stage apparatus comprising a first stage, a driving unit configured to drive the first stage in a first direction, a second stage mounted on the first stage; a linear motor configured to position the second stage relative to the first stage, a plurality of electromagnets which are inserted between the first stage and the second stage, are configured to apply forces to the second stage in the first direction, align themselves in a direction perpendicular to the first direction, and include coils, a measuring device configured to measure a rotation amount of the second stage relative to the first stage, and a controller configured to control an electric current supplied to each of the coils, wherein the controller controls the electric current supplied to each of the coils based on the measurement result obtained by the measuring device.

According to the third aspect of the present invention, there is provided a stage apparatus comprising a first stage, a driving unit configured to drive the first stage in a first direction, a second stage mounted on the first stage; a linear motor configured to position the second stage relative to the first stage, a plurality of electromagnets which are inserted between the first stage and surfaces of the second stage which face the first direction, are configured to support the second stage in a non-contacting manner with respect to the first stage, and include coils, and a controller configured to control an electric current supplied to each of the coils, the plurality of electromagnets including an electromagnet configured to produce a force to rotate the second stage relative to the first stage in a first rotation direction in a plane on which the first stage is driven, and an electromagnet configured to produce a force to rotate the second stage relative to the first stage in a direction opposite to the first rotation direction in the plane on which the first stage is driven, wherein the controller controls the electric current supplied to each of the coils so as not to rotate the second stage relative to the first stage upon driving the first stage.

According to the present invention, it is possible to provide a stage apparatus which reduces any moments generated by electromagnets due to rotation of a fine motion stage by controlling the electromagnets, thereby suppressing heat generation by a fine motion linear motor.

Further features of the present invention will become apparent from the following description of exemplary embodiments with reference to the attached drawings.

### BRIEF DESCRIPTION OF THE DRAWINGS

FIG. 1 is a plan view showing a stage apparatus according to the first embodiment;

FIG. 2 is a view showing electromagnets according to the first embodiment;

FIG. 3 is a block diagram illustrating an example of a control system for the electromagnets according to the first embodiment;

FIG. 4 is a block diagram illustrating another example of the control system for the electromagnets according to the first embodiment;

FIG. 5 is a plan view showing a stage apparatus according to the second embodiment;

FIG. 6 is a plan view showing a stage apparatus according to the third embodiment; and

FIG. 7 is a view illustrating an example of an exposure apparatus.

### DESCRIPTION OF THE EMBODIMENTS

Embodiments of the present invention will be described below with reference to the accompanying drawings.

### First Embodiment

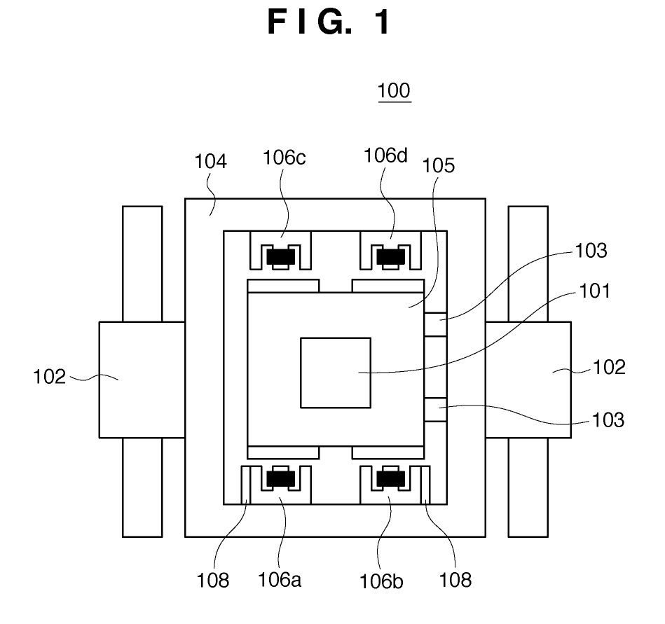

FIG. 1 illustrates an example of a stage apparatus according to the present invention. Although this stage apparatus is implemented as a stage which supports an original (reticle) of an exposure apparatus which transfers a pattern formed on the original (reticle) onto a substrate, it can also be applied to, for example, a stage which supports the substrate.

An original stage 100 holds an original (reticle) 101 and conveys and positions the original 101 to an exposure position. A coarse motion stage 104 serving as a first stage in the original stage 100 is driven by a coarse motion linear motor 102 serving as a driving unit. A fine motion stage 105 serving as a second stage is mounted on the coarse motion stage 104. The fine motion stage 105 is supported in a non-contacting manner with respect to the coarse motion stage 104 by a fine motion linear motor 103 and a plurality of electromagnets 106a to 106d. The fine motion stage 105 is driven so as to move relative to the coarse motion stage 104. The plurality of electromagnets 106a to 106d accelerate and decelerate the fine motion stage 105 relative to the coarse motion stage 104, and produce thrusts controlled to reduce any moments generated by the electromagnets 106a to 106d due to rotation of the fine motion stage 105. The electromagnets 106b and 106c produce forces to rotate the fine motion stage 105 in a first rotation direction (the clockwise direction in FIG. 1) on the plane on which the fine motion stage 105 is driven. The electromagnets 106a and 106d produce forces to rotate the fine motion stage 105 in a direction (the counterclockwise direction in FIG. 1) opposite to the first rotation direction in the plane on which the fine motion stage 105 is driven. The linear motor (fine motion linear motor) 103 for moving the fine motion stage 105 accurately positions it. Hence, the fine motion linear motor 103 need not control rotation of the fine motion stage 105, thus suppressing heat generation by the fine motion linear motor 103.

The stage apparatus comprises measuring devices each of which measures the rotation amount of the fine motion stage 105 relative to the coarse motion stage 104. An example of the measuring devices each of which measures the rotation amount is a plurality of gap sensors 108 inserted between the electromagnets 106a to 106d and the fine motion stage 105. The plurality of gap sensors 108 measure the positions of the fine motion stage 105 relative to the electromagnets 106a to 106d in its translation direction and rotation direction. The measuring devices each of which measures the rotation amount may be a plurality of laser interferometers (not shown) which are placed outside the original stage and measure the positions of the fine motion stage 105.

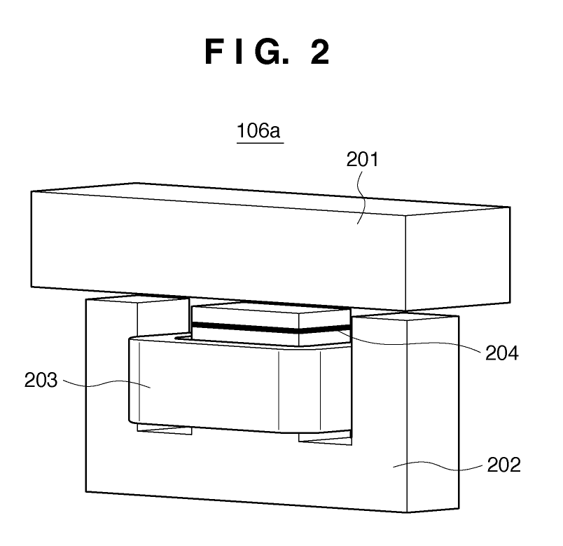

FIG. 2 is a view illustrating an example of the plurality of electromagnets 106a to 106d. A small gap is formed between a yoke 202 and magnetic plate 201 of the electromagnet 106a so that a force can be transmitted between them in a non-contacting manner. When an electric current is supplied to a driving coil 203 attached to the electromagnet main body, an attraction force acts between the yoke 202 and the magnetic plate 201. A search coil 204 is wound around the yoke 202 of the electromagnet 106a, and measures its own induced voltage.

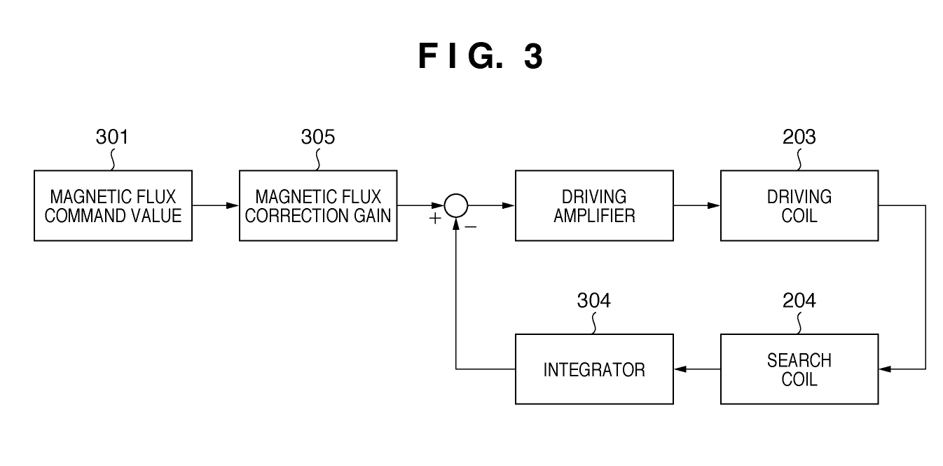

FIG. 3 shows a control system for a controller which controls the plurality of electromagnets 106a to 106d. The controller corrects the driving target of the fine motion stage 105 in accordance with the measurement results obtained by the measuring devices. Based on the corrected driving target, the controller also controls the plurality of electromagnets 106a to 106d so as to reduce any moments generated by the electromagnets 106a to 106d due to rotation of the fine motion stage 105. The force produced by each of the electromagnets 106a to 106d is proportional to the square of a magnetic flux running between each of the electromagnets 106a to 106d and the magnetic plate 201. The control system for the electromagnets 106a to 106d receives a command value (magnetic flux command) 301 of a magnetic flux, which is in the dimension of the square root of the absolute value of an acceleration or deceleration force, from the controller. The induced voltage measured by the search coil 204 is integrated by an integrator 304, and the integrated value becomes the dimension of the magnetic flux. Based on this output, the magnitude of a magnetic flux which produces a desired thrust is calculated. In order to drive the fine motion stage 105 at a desired rotation position by measuring the rotation amount of the fine motion stage 105 using, for example, each gap sensor, the command value of each of the electromagnets 106a to 106d is multiplied by a magnetic flux correction coefficient (magnetic flux correction gain) 305 corresponding to the rotation amount. The magnetic flux correction coefficient 305 is preferably predicted in advance. A moment amount corresponding to the rotation amount is measured in advance to obtain a desired rotation amount, and a thrust correction coefficient which cancels a moment generated in the fine motion stage 105 is calculated for each of the electromagnets 106a to 106d. Since the thrust is proportional to the square of the magnetic flux, a magnetic flux correction coefficient input in response to the magnetic flux command is preferably obtained by approximating the relationship between the stage rotation amount and the square root of the calculated thrust correction coefficient by a first-order function. Note that the approximation may be done by a first- or higher-order function. The relationship between the thrust correction coefficient and the stage rotation amount may be approximated by a first- or higher-order function so that the square root of the approximation function is determined as the magnetic flux correction coefficient.

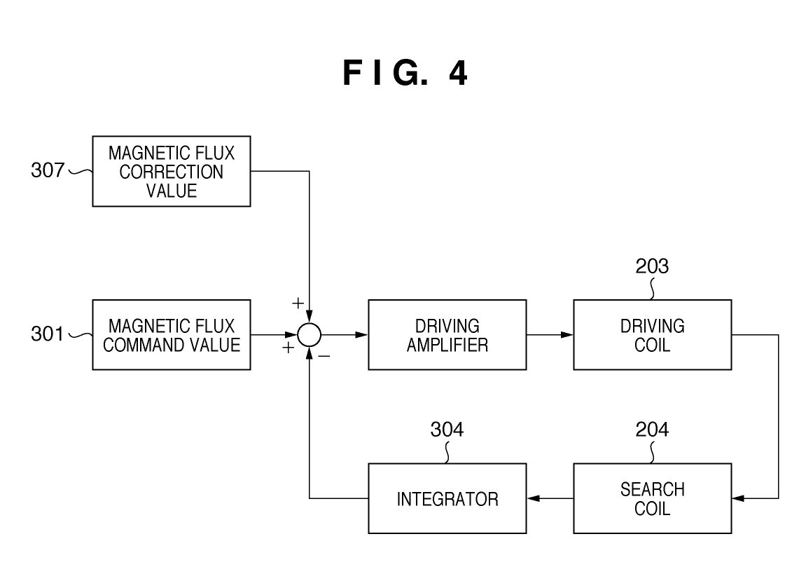

In FIG. 4, a magnetic flux correction value 307 corresponding to a desired rotation amount is added to the command value of each of the electromagnets 106a to 106d in order to drive the fine motion stage 105 at a desired rotation position by measuring the rotation amount of the fine motion stage 105 relative to each of the electromagnets 106a to 106d as in FIG. 3. The correction value 307 is preferably predicted in advance. A moment amount corresponding to the rotation amount is measured in advance to obtain a desired rotation amount, and a thrust correction value which cancels a moment generated in the fine motion stage is calculated for each electromagnet.

### Second Embodiment

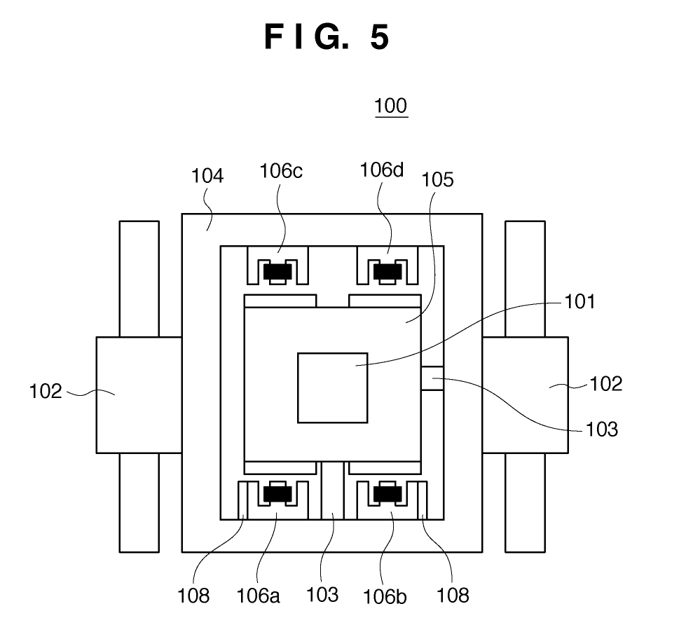

FIG. 5 shows the second embodiment. In the second embodiment, the number of axes of a fine motion linear motor 103 is decreased as compared with that in the first embodiment. Electromagnets 106a to 106d assist the translation of the fine motion linear motor 103 and position the fine motion linear motor 103 in the rotation direction.

### Third Embodiment

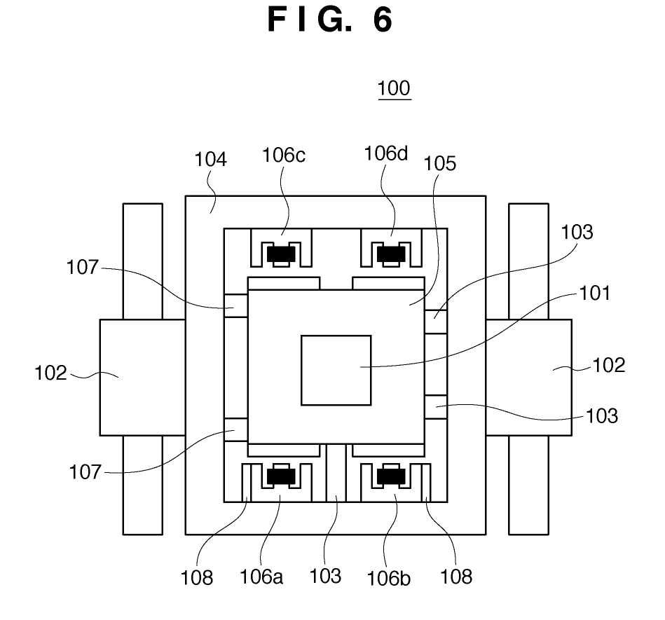

FIG. 6 shows the third embodiment. In the third embodiment, a plurality of force measuring devices 107 such as strain gauges are set at the connection portions between a fine motion stage 105 and a coarse motion stage 104. Each of the plurality of force measuring devices 107 measures a moment generated in the fine motion stage 105, and calculates a correction value for the magnetic flux command value of each of electromagnets 106a to 106d so as to cancel the generated moment. The magnetic flux command value is multiplied by or added to this correction value, thereby performing thrust correction. This force measurement may be done by measuring the reaction force of a fine motion linear motor 103. That is, the current value of the linear motor is detected, and the correction value for the magnetic flux command value of each of the electromagnets 106a to 106d is calculated in accordance with the detected current value.

### Embodiment of Exposure Apparatus

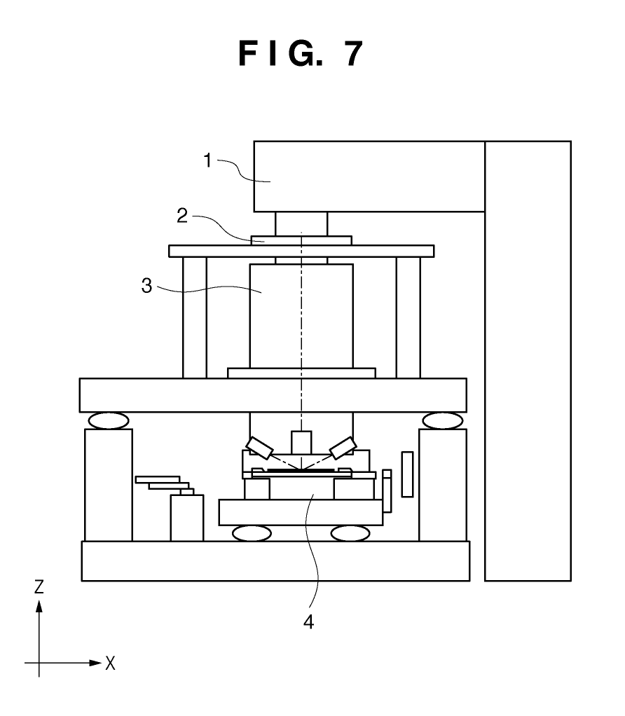

An exemplary exposure apparatus to which a stage apparatus according to the present invention is applied will be explained below. As shown in FIG. 7, a projection exposure apparatus has an illumination unit 1, an original stage 2 which mounts an original (reticle), a projection optical system 3, and a substrate stage 4 which mounts a substrate. The exposure apparatus projects and transfers a circuit pattern formed on the original onto the substrate, and may be of the step & repeat projection exposure scheme or the step & scan projection exposure scheme.

The illumination unit 1 illuminates an original on which a circuit pattern is formed, and has a light source unit and illumination optical system. The light source unit uses, for example, a laser as a light source. The laser can be, for example, an ArF excimer laser with a wavelength of about 193 nm, a KrF excimer laser with a wavelength of about 248 nm, or an F₂ excimer laser with a wavelength of about 153 nm. The type of laser is not particularly limited to an excimer laser and may be, for example, a YAG laser, and the number of lasers is not particularly limited either. When a laser is used as the light source, a light beam shaping optical system for shaping a parallel light beam from the laser light source into a desired beam shape, and an incoherent optical system for converting a coherent laser beam into an incoherent one are preferably used. Also, the light source which can be used for the light source unit is not particularly limited to a laser, and one or a plurality of mercury lamps or xenon lamps can be used. The illumination optical system illuminates a mask and includes, for example, a lens, mirror, optical integrator, and stop.

The projection optical system 3 can be, for example, an optical system having a plurality of lens elements alone, an optical system having a plurality of lens elements and at least one concave mirror, an optical system having a plurality of lens elements and at least one diffractive optical element, or an optical system having a total reflection mirror.

The original stage 2 and substrate stage 4 can move by linear motors. In the step & scan projection exposure scheme, the stages 2 and 4 move synchronously. An actuator is separately provided to at least one of the substrate stage 4 and original stage 2 to align the original pattern onto the substrate.

The above-described exposure apparatus can be used to manufacture micropatterned devices, for example, a semiconductor device such as a semiconductor integrated circuit, a micromachine, and a thin-film magnetic head.

Devices (e.g., a semiconductor integrated circuit device and liquid crystal display device) are manufactured by a step of exposing a substrate to radiant energy using the above-described exposure apparatus, a step of developing the substrate exposed in the exposing step, and other known steps of processing the substrate developed in the developing step.

In resist removal, any unnecessary resist remaining after etching is removed. By repeating these steps, a multilayered structure of circuit patterns is formed on the substrate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-173108, filed Jun. 29, 2007, which is hereby incorporated by reference herein in its entirety.

What is claimed is:

1. A stage apparatus comprising:
a first stage;
a second stage mounted on said first stage;
a linear motor configured to position said second stage relative to said first stage;
a plurality of electromagnets configured to accelerate and decelerate said second stage relative to said first stage; and
a controller configured to control said plurality of electromagnets,
wherein said controller controls said electromagnets so as to reduce moments generated by said electromagnets due to rotation of said second stage.

2. The apparatus according to claim 1, further comprising
a measuring device configured to measure a rotation amount of said second stage relative to said first stage,
wherein said controller controls said electromagnets based on the measurement result obtained by said measuring device.

3. The apparatus according to claim 1, further comprising
a measuring device configured to measure a moment generated in said second stage,
wherein said controller controls said electromagnets based on the measurement result obtained by said measuring device.

4. The apparatus according to claim 1, wherein said controller corrects a driving target of said second stage in accordance with a current value of said linear motor, and controls said electromagnets based on the corrected driving target.

5. The apparatus according to claim 2, wherein said measuring device includes either of a plurality of gap sensors configured to measure gaps between said second stage and said plurality of electromagnets, and a plurality of interferometers configured to measure positions of said second stage.

6. The apparatus according to claim 2, wherein said controller corrects a driving target of said second stage in accordance with the measurement result obtained by said measuring device, and controls said electromagnets based on the corrected driving target.

7. The apparatus according to claim 3, wherein said controller corrects a driving target of said second stage in accordance with the measurement result obtained by said measuring device, and controls said electromagnets based on the corrected driving target.

8. An exposure apparatus which transfers a pattern formed on an original onto a substrate, wherein
at least one of the original and the substrate is supported by a stage apparatus defined in claim 1.

9. A method of manufacturing a device, the method comprising:
exposing a substrate to radiant energy using an exposure apparatus defined in claim 8;
developing the exposed substrate; and
processing the developed substrate to manufacture the device.

10. A stage apparatus comprising:
a first stage;
a driving unit configured to drive said first stage in a first direction;
a second stage mounted on said first stage;
a linear motor configured to position said second stage relative to said first stage;
a plurality of electromagnets which are inserted between said first stage and said second stage, are configured to apply forces to said second stage in the first direction, align themselves in a direction perpendicular to the first direction, and include coils;
a measuring device configured to measure a rotation amount of said second stage relative to said first stage; and
a controller configured to control an electric current supplied to each of said coils,
wherein said controller controls the electric current supplied to each of said coils based on the measurement result obtained by said measuring device.

11. The apparatus according to claim 10, wherein said measuring device includes either of a plurality of gap sensors configured to measure gaps between said second stage and said plurality of electromagnets, and a plurality of interferometers configured to measure positions of said second stage.

12. The apparatus according to claim 10, wherein said controller corrects a driving target of said second stage in accordance with the measurement result obtained by said measuring device, and controls the electric current, which is supplied to each of said coils, based on the corrected driving target.

13. The apparatus according to claim 10, wherein said controller corrects a driving target of said second stage in accordance with a current value of said linear motor, and controls the electric current, which is supplied to each of said coils, based on the corrected driving target.

14. An exposure apparatus which transfers a pattern formed on an original onto a substrate, wherein
at least one of the original and the substrate is supported by a stage apparatus defined in claim 10.

15. A method of manufacturing a device, the method comprising:
exposing a substrate to radiant energy using an exposure apparatus defined in claim 14;
developing the exposed substrate; and
processing the developed substrate to manufacture the device.

16. A stage apparatus comprising:
a first stage;
a driving unit configured to drive said first stage in a first direction;
a second stage mounted on said first stage;
a linear motor configured to position said second stage relative to said first stage;
a plurality of electromagnets which are inserted between said first stage and surfaces of said second stage which face the first direction, are configured to support said second stage in a non-contacting manner with respect to said first stage, and include coils; and
a controller configured to control an electric current supplied to each of said coils,
said plurality of electromagnets including an electromagnet configured to produce a force to rotate said second stage relative to said first stage in a first rotation direction in a plane on which said first stage is driven, and an electromagnet configured to produce a force to rotate said second stage relative to said first stage in a direction opposite to the first rotation direction in the plane on which said first stage is driven,
wherein said controller controls the electric current supplied to each of said coils so as not to rotate said second stage relative to said first stage upon driving said first stage.

17. The apparatus according to claim 16, further comprising
a measuring device configured to measure a rotation amount of said second stage relative to said first stage,
wherein said controller controls the electric current, which is supplied to each of said coils, based on the measurement result obtained by said measuring device.

18. The apparatus according to claim 16, further comprising
a measuring device configured to measure a moment generated in said second stage,
wherein said controller controls the electric current, which is supplied to each of said coils, based on the measurement result obtained by said measuring device.
